(19) United States
(12) Patent Application Publication
(10) Pub. No.: US 2011/0202634 A1
(43) Pub. Date: Aug. 18, 2011

(54) CHARGING-INVARIANT AND ORIGIN-SERVER-FRIENDLY TRANSIT CACHING IN MOBILE NETWORKS

(76) Inventors: Surya Kumar Kovvali, Westborough, MA (US); Krishnan Ramakrishnan, Hopkinton, MA (US); Gregory Alden, Alexandria, VA (US)

(21) Appl. No.: 13/025,839

(22) Filed: Feb. 11, 2011

Related U.S. Application Data
(60) Provisional application No. 61/304,141, filed on Feb. 12, 2010.

(51) Int. Cl. G06F 15/16

(52) U.S. Cl. 709/219

(57) ABSTRACT

A method for serving content from a radio-access network cache includes detecting a request from a mobile device for content in the cache. The request is sent to a content-origin server, and a response is received therefrom.

### CROSS-REFERENCE TO RELATED APPLICATIONS

This application claims priority to and the benefit of U.S. Provisional Patent Application Ser. No. 61/304,141, filed on Feb. 12, 2010, which is hereby incorporated herein by reference in its entirety.

### TECHNICAL FIELD

Embodiments of the invention generally relate to radio-access networks and, in particular, to caching content therein.

### BACKGROUND OF THE INVENTION

Operators of mobile communications networks often have subscription plans that charge subscribers for content (e.g., audio/video data) as it is used and/or set a limit for the amount of content allowed to be uploaded or downloaded in a certain time period. These operators may use an accounting system to track each user's consumption of content (supplied by, e.g., third-party content providers); the use of a cache or proxy device, however, may present a challenge to the accounting system. When a cache delivers content to a user, the user's subscription plan may not be charged because the content delivery may take place without notification to the accounting device. In the case of an internet-based cache or proxy, core-network devices (e.g., an SGSN or GGSN in a UMTS network) in the mobile operator's network may perform accounting functions while delivering content to user devices through a radio access network (“RAN”). Therefore content delivered by an internet-based cache or proxy is accounted for by core network devices as it is delivered via the RAN.

When a content caching device is placed in the RAN (i.e., a “RAN cache”), however, the core network devices and the accounting system are unaware of the RAN cache, any content cached by it, and any content served from the RAN cache in response to subsequent user requests. Additionally, content providers may prefer to receive user requests for certain objects (e.g., top pages) for purposes of content-based monetization and for serving dynamic and opportunistic content such as profile-based, context-based, and location-based advertisements. To serve this type of dynamic content, content providers often mark certain objects as non-cacheable or with a small expiration timer. Both of these strategies prevent or limit the caching of content in a RAN cache, thereby increasing the time for content delivery to a user's mobile device. A need therefore exists for a charging-invariant and content-provider-friendly RAN cache.

### SUMMARY OF THE INVENTION

Embodiments of the present invention include a method and system for accounting for content served from a RAN cache, thereby allowing for mobile communications providers to charge users for the content they access. Benefits include increased use of content caches by content providers and network operators, lessened network lag time, faster downloads and uploads, and increased quality of user experiences. In one embodiment, this accounting is called charging-invariant transit caching (“CITC”). CITC includes delivering content to a user from a RAN cache without waiting for a response from the content server if the user's request meets the criteria of caching and expiration tags on previously cached content. If there is no cached copy of the content in the CITC device, the CITC device may treat the request as a cache miss (i.e., the CITC device retrieves that content from the content servers, caches it, and passes it on to the user). Such a cache-miss operation propagates the user's request and the corresponding response through one or more core network devices for accounting and/or charging. In the case of a cache hit (i.e., the requested object is found in the RAN cache), the CITC device may return the requested object from local cache and, in parallel, the CITC device may forward each user content request to the content provider so that the mobile network's accounting devices can register the appropriate charge to the user's account. The CITC device may then update the RAN cache and expiration timers based on the response from the content servers.

In one embodiment, the CITC device adds an HTTP tag called, e.g., “CITC,” that communicates to content providers and origin servers that the cache system is friendly to them by permitting proper charging of users for content accessed, as it makes every user's content requests visible to the origin servers. This HTTP tagging permits content providers to configure origin servers or transit content delivery networks or transit content distribution networks to respond to the CITC device, thus making increased caching more likely as origin servers may mark more objects as cacheable and use larger expiration timers.

Accordingly, in one aspect, a method serves content from a radio-access network cache. A request is detected from a mobile device for content present in the radio-access network cache. The request is sent to a content-origin server. A response is received from the content-origin server related to the request.

In various embodiments, detecting the request includes receiving a client request from the mobile device or from the radio-access network cache. The response received from the content-origin server may include the requested content and/or an indication to halt serving the content from the radio-access network cache. The indication to halt serving the content from the radio-access network cache may include a message that the request is denied or that the content requested is invalid. The indication to halt serving the content from the radio-access network cache may include instructing the radio-access network cache to halt serving the content. Sending the request to the content-origin server may occur in parallel with serving the content from the radio-access network cache or after serving the content from the radio-access network cache.

In various embodiments, the request sent to the content-origin server is tagged with a tag indicating presence of a content-origin-server-friendly radio-access network cache. The response received from the content-origin server may include content modified for compatibility with the content-origin-server-friendly radio-access network cache. The modifications may include flagging the content as cacheable or increasing the expiration time of the content. The response received from the content-origin server may include content to be served in a future request. The content to be served in the future request may include an advertisement.

In various embodiments, an amount of data delivered to the mobile device is compared to an amount of data received from the content-origin server. Based on an outcome of the comparison, the method may include indicating undercharging or overcharging and/or may include controlling an amount of data delivered from the radio-access network cache, prior to fetching the data from the content-origin server. Controlling the amount of delivered data may minimize an impact on an accounting and charging system in a mobile core network and/or may minimize an impact on any legal intercept issues in a mobile core network.

In another aspect, a system serves content from a radio-access network cache. The system includes an interface module for sending data to and receiving data from a radio-access network, a detection module for detecting a request, sent from a mobile device and received via the radio-access network, for content present in a radio-access network cache, and a communication module for sending the request to a content-origin server and receiving a response therefrom.

In various embodiments, the system includes a security module for verifying that the mobile device is allowed to receive the content. The security module may halt serving of the content from the radio-access network cache if the mobile device is not allowed to receive the content. The communication module may receive the content from the content-origin server. The communication module may tag the forwarded request with a tag indicating presence of a content-origin-server-friendly radio-access network cache. The system may include an accounting module for comparing an amount of data delivered to the mobile device to an amount of data received from the content-origin server. The system may include a cache-interface module for communicating with a radio-access network cache. The cache-interface module may forward content received from the content-origin server to the radio-access network cache.

In another aspect, a system serves content from a radio-access network cache. The system includes computer memory for storing instructions for detecting a request, sent from a mobile device via a radio-access network, for content present in the radio-access network cache, sending the request to a content-origin server, and receiving a response from the content-origin server related the request. The system also includes a processor for executing the instructions.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a network that includes user equipment, a RAN, a core network, the Internet, and a content cache deployed outside the RAN;

FIG. 2 is a block diagram of a device implementing a RAN cache in accordance with an embodiment of the invention;

FIG. 3 is a block diagram of a system for serving content from a RAN cache in accordance with an embodiment of the invention;

FIG. 4 is four block diagrams illustrating a network that includes the Internet, a RAN, and a CITC device in accordance with an embodiment of the invention;

FIG. 5 is a block diagram illustrating a CITC device in a 4G RAN in accordance with an embodiment of the invention;

FIG. 6 is a block diagram illustrating a CITC device in a wire-line access network in accordance with an embodiment of the invention;

FIG. 7 is a diagram illustrating a TCP connection and HTTP request processing;

FIG. 8 is a diagram illustrating a TCP connection and HTTP request processing when the requested content is not found in the cache in accordance with an embodiment of the invention;

FIG. 9 is a diagram illustrating a TCP connection and HTTP request processing when the requested URL is found in the cache in accordance with an embodiment of the invention;

FIG. 10 is a block diagram illustrating a RAN cache in accordance with an embodiment of the invention; and

FIG. 11 is a block diagram illustrating a charging-invariant transit caching process in accordance with an embodiment of the invention.

### DETAILED DESCRIPTION

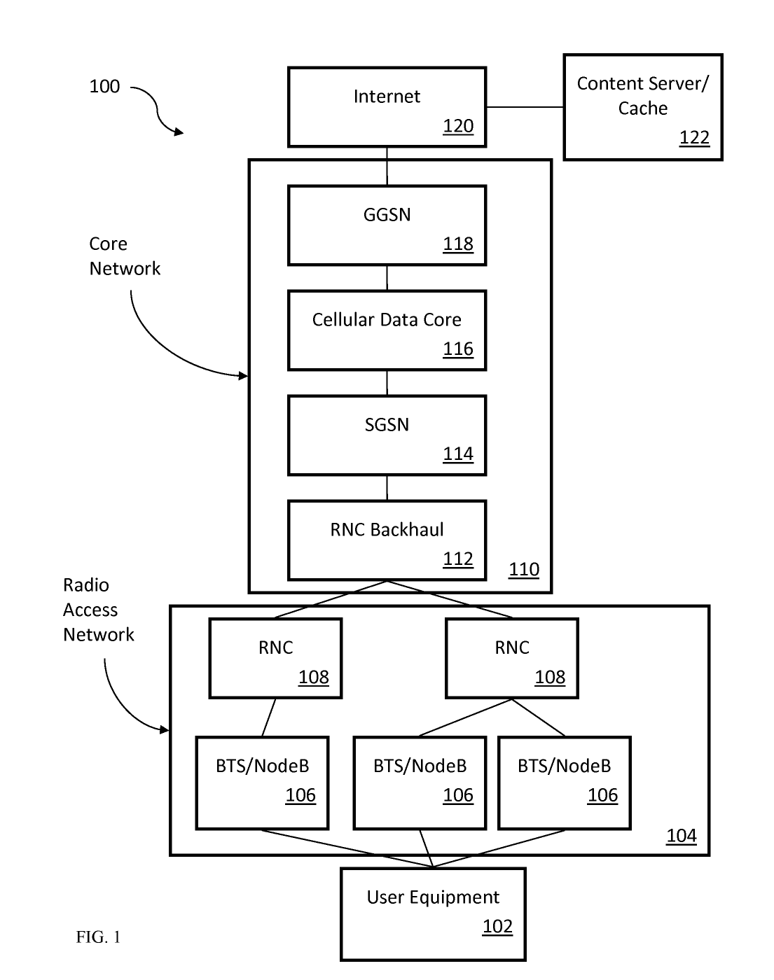

FIG. 1 illustrates a network 100 that includes user equipment 102, a RAN 104, a core network 110 connected to the Internet 120, and a content server/cache 122. The content server/cache 122 may be or include a content-aware web cache or a content-origin server. The RAN 104 may include one or more BTS/NodeBs 106 connected to one or more RNCs 108, as shown in FIG. 1. The core network 110 may be a UMTS network and may include an RNC backhaul 112, an SGSN 114, a cellular data core 116, and/or a GGSN 118. Note that while the examples and descriptions here illustrate a 3G/UMTS/HSDPA wireless network, the invention may be embodied in any RAN, including but not limited to GSM/GPRS, CDMA, LTE, or WIMAX networks, or in wire-line access networks. For example, the NodeBs 106 in a UMTS network may be BTSs in a GSM network. The core network 110 connects to the Internet 120 through the GGSN 118. A content-aware web cache 122, deployed outside of the RAN 104, is connected to the Internet 120. The content server/cache 122 delivers content, if a cache hit is found. Network operators may account and charge for content usage (e.g., bytes downloaded per month) for users of a RAN, maintain usage quotas per plan period (e.g. bytes per month), and/or offer pre-paid or post-paid charging. This accounting and charging is typically handled at the interface between the mobile network and the Internet 120, at the GGSN 118, and/or at another accounting device (e.g., a PDSN in a CDMA network).

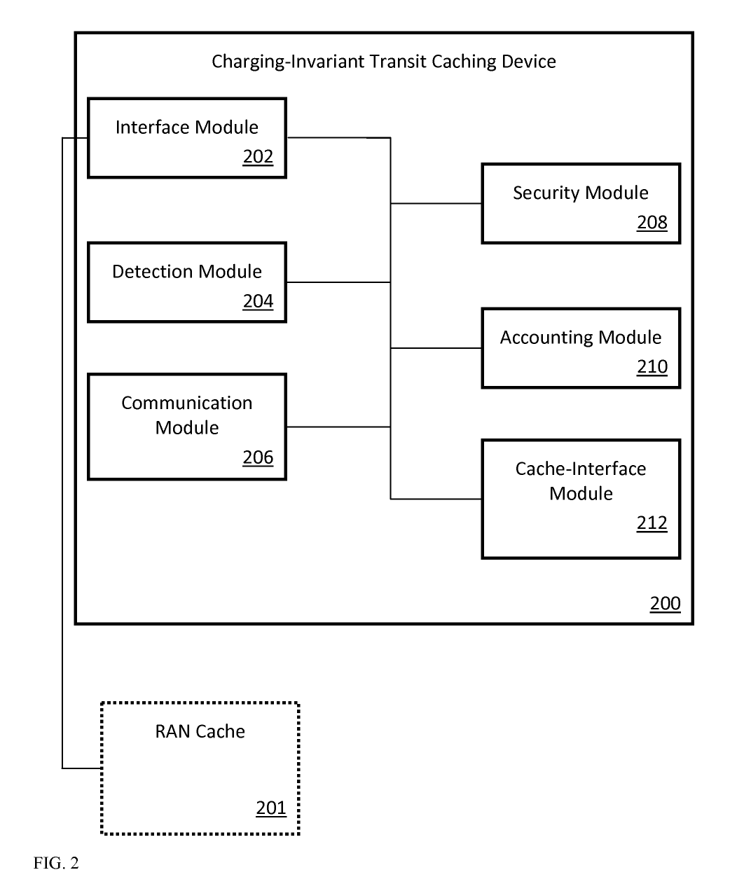

FIG. 2 illustrates a CITC device 200 for serving content from a RAN cache 201. In one embodiment, an interface module 202 sends data to and receives data from a RAN, e.g. the RAN 104 illustrated in FIG. 1. The interface module 202 may detect a request for content originating from user equipment, e.g. the user equipment 102 illustrated in FIG. 1, by either receiving the request directly or having the request relayed from the RAN cache 201. A detection module 204 detects a request from user equipment 102, received via the RAN 104, for content present in a RAN cache 201. The content may be cached and delivered based on the request and/or response headers in the transport protocols. At the same time, a communication module 206 may send the request for content to a content-origin server, e.g. the content-origin server 122 illustrated in FIG. 1, in the Internet and receive a response from the content server/cache 122. The response may include the content from the content-origin server 122. The communication module 206 may tag the forwarded request with a tag indicating the presence of a content-origin-server-friendly RAN cache. A security module 208 may verify that the mobile device is allowed to receive the content, and may halt serving of the content from the RAN cache to the user equipment 102 if the mobile device is not allowed to receive the content. An accounting module 210 may compare an amount of data delivered to the user equipment 102 to an amount of data received from the content-origin server 122. A cache-interface module 212 may communicate with a RAN cache 201. The cache-interface module 212 may forward content received from the content-origin server 122 to the RAN cache 201. In one embodiment, CITC may be implemented with a device, a program, or other means separate from the RAN cache 201. Alternatively, some or all of the CITC functions may be part of the RAN cache 201.

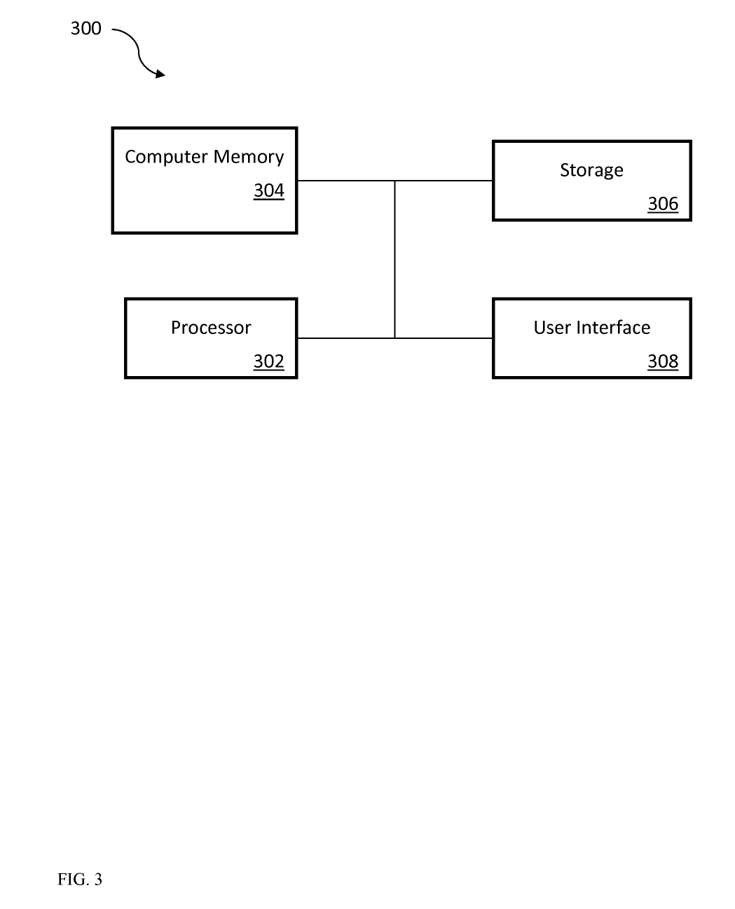

FIG. 3 illustrates a system 300 for serving content from a RAN cache in accordance with an embodiment of the invention. Computer memory 304 stores instructions for detecting a request sent from a mobile device via a RAN for content present in the RAN cache. The computer memory 304 also stores instructions for sending the request from the user interface 308 to the content-origin server 122, and the computer memory 304 stores instructions for receiving a response from the content-origin server 122 related to the request. The system 300 includes a processor 302 for executing the instructions in the computer memory. The system 300 may interface with a storage element 306, which may be implemented with any appropriate storage technology known in the art, such as random-access memory, flash memory, or a block storage device (e.g., a magnetic or solid-state disk).

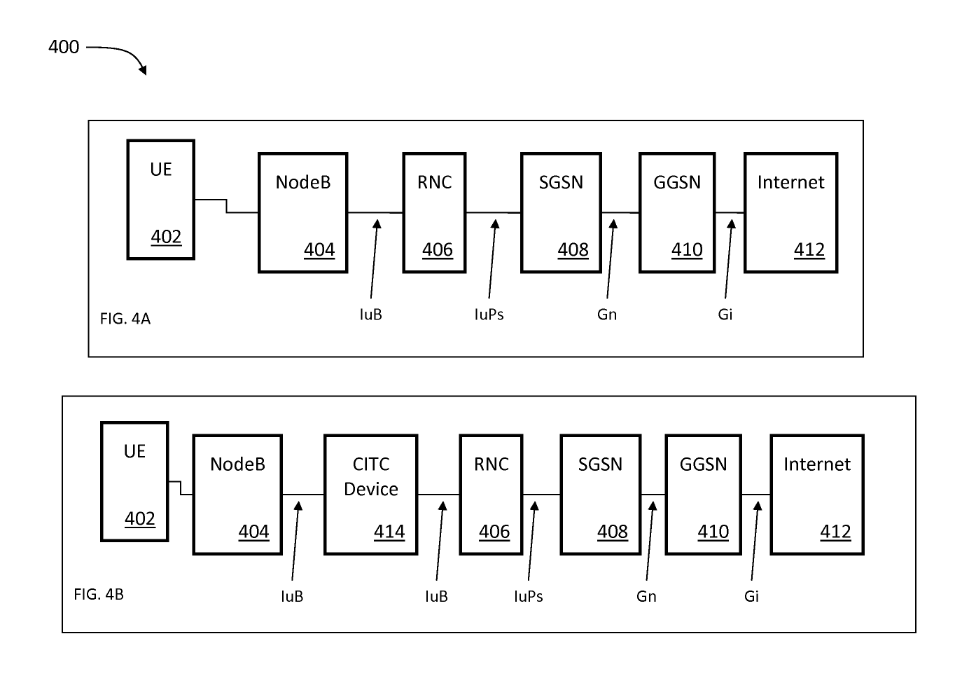

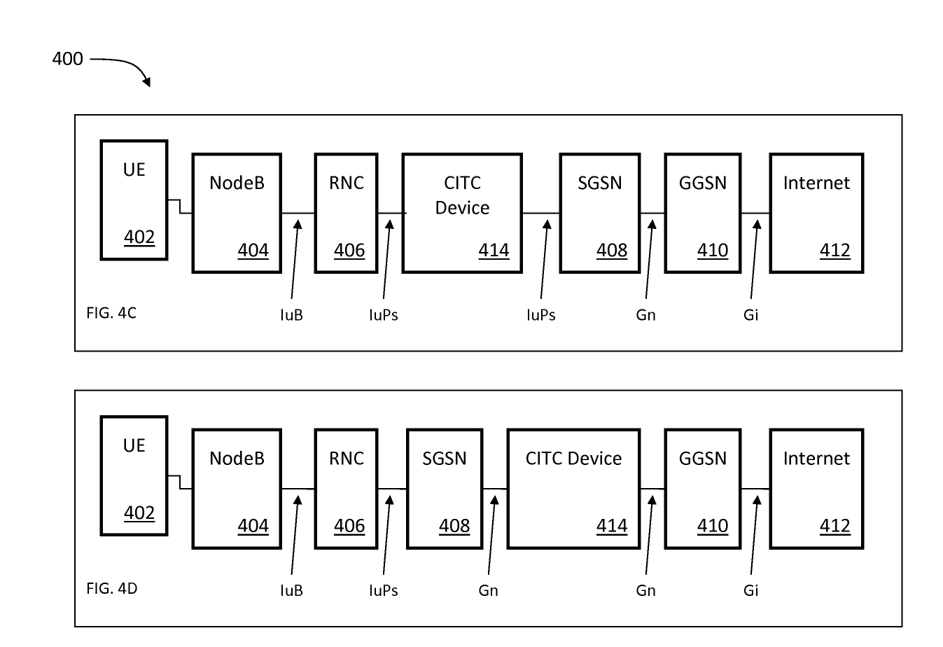

FIGS. 4A-4D illustrate various embodiments of the invention in which a CITC device is placed in different locations in a RAN. In FIG. 4A, the network 402-410 illustrated is a 3G RAN connected to the Internet 412. The network may include user equipment 402, connected to a NodeB 404 (a base station), which is connected to an RNC 406 by an interface (called the IuB) between the NodeB 404 and the RNC 406. The RNC 406 connects to an SGSN 408 with another interface (the IuPS), and the SGSN 408 connects to a GGSN 410 with another interface (the Gn). The GGSN 410 connects to the Internet 412 via an interface called a GI. In FIG. 4B, illustrating one embodiment of the invention, the CITC device 414 is disposed on the IuB interface between the NodeB 404 and the RNC 406, in which the underlying transport on the IuB interface may be ATM or IP. In FIG. 4C, the CITC device 414 is disposed on the IuPS interface between the RNC 406 and the SGSN 408. The CITC device 414 there may intercept IuPS control-plane and user-plane protocols in the packet-switched domain. The underlying transport on the interface may be ATM or IP. In FIG. 4D, the CITC device 414 is disposed on the Gn interface, between the SGSN 408 and the GGSN 410.

In some embodiments, the CITC device 414 is deployed in a network having one or more traffic-offload interfaces that offload selected portions of user-requested content from the core network to a local-internet interface and/or to content-delivery network devices, thereby bypassing the normal core network (e.g., the SGSN/GGSN). In such embodiments, the CITC device 414 uses either the core network or the appropriate offload interface per the offload configuration policy while performing the transit caching methods per the current invention.

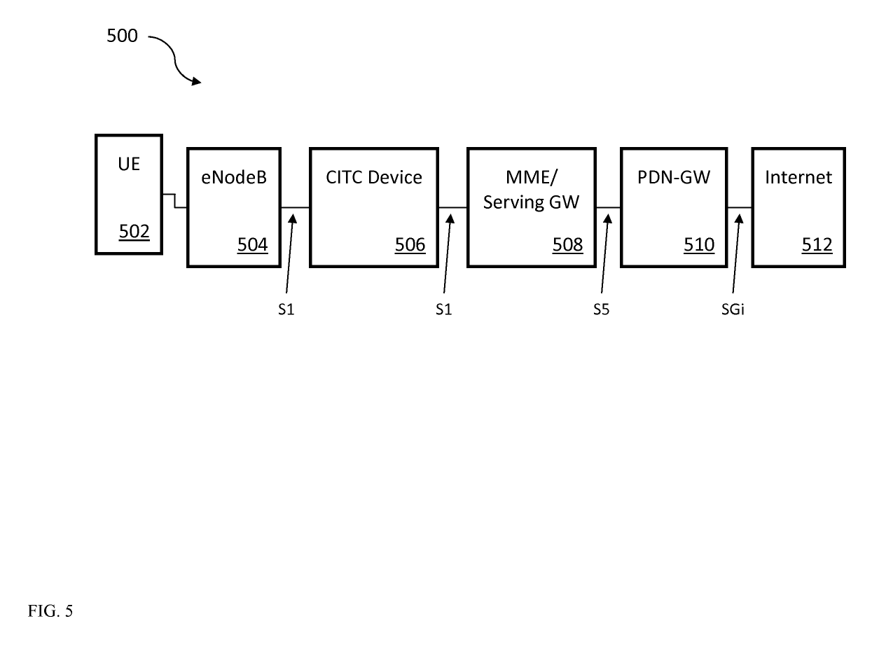

FIG. 5 illustrates placement of a CITC device 506 in a 4G RAN 500. The 4G RAN 500 may include user equipment 502, an eNodeB 504, an MME/serving GW 508, and a PDN-GW 510, which connects to the Internet 512. In this embodiment of the invention, the CITC device 506 is placed on the S1 interface between the eNodeB 504 and the MME/serving GW 508, where the CITC device 506 intercepts data traffic. The MME/Serving GW 508 interfaces with the PDN-GW 510 via an S5 interface, which interfaces with the Internet 512 via an SGi interface.

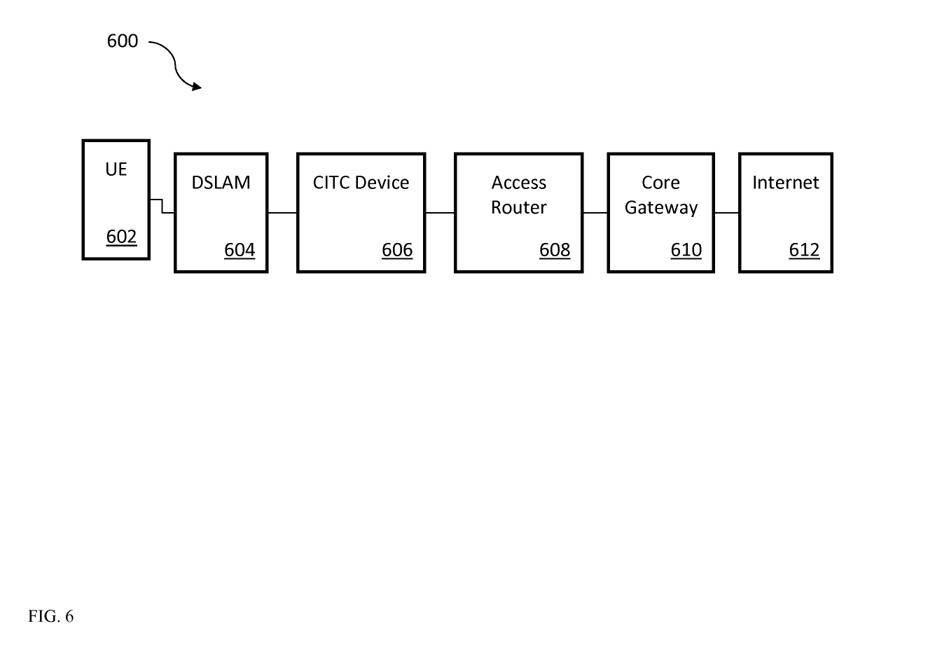

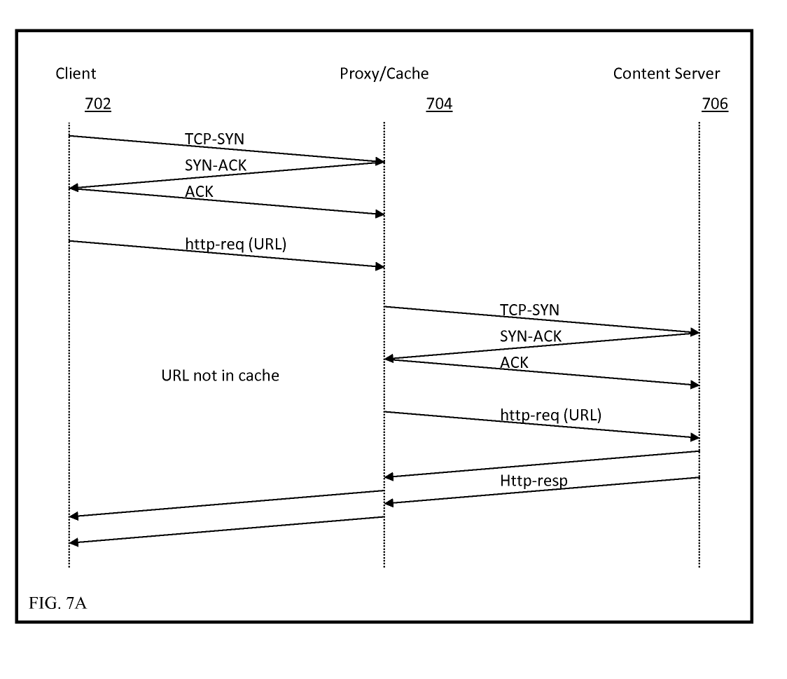

FIG. 6 illustrates placement of the CITC device 606 in a wire-line access network 600. The user equipment 602 connects to the DSLAM 604. The CITC device 606 may be placed between the DSLAM 604 and the access router 608. The access router 608 interfaces with a core gateway 610, which connects to the Internet 612.

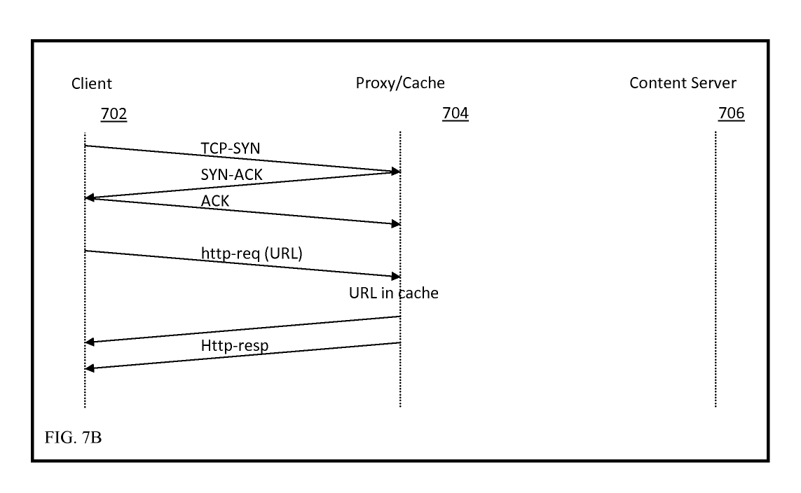

FIGS. 7A and 7B illustrate processing of TCP connections and HTTP requests relating to a client device 702, a proxy or cache 704, and a content server 706. FIG. 7A illustrates a case in which requested content is not present in the cache 704. The client device 702 initiates a standard TCP connection protocol, TCP-SYN, which is received by the cache 704. The cache 704 responds to the client device 702 with SYN-ACK, and the client device 702 responds to the proxy/cache 704 with ACK and then sends its HTTP request. The cache 704 then initiates the same TCP connection protocols (TCP-SYN, SYN-ACK, ACK) with the content server 706, and then sends the HTTP request of the client device 702 to the content server 706. Upon receiving the HTTP response from the content server 706, which may contain the content requested by the client device 702, the proxy/cache 704 sends that response to the client device 702. The content may include data, text, audio, video, metadata, protocols (e.g. URLs), and/or any other type of content. Note that the cache 704 does not initiate communication with the content server 706 until the TCP connection handshake with the client 702 is complete. This delay may lead to increased lag time and latency from the point of view of the client 702.

FIG. 7B illustrates a case in which the requested content is present in the cache 704. The TCP connection between the client 702 and the cache 704 is as described above for FIG. 7A. When the client 702 sends an HTTP request to the cache 704, the cache 704 responds to the client with the content requested and does not communicate with the content server 706 with a TCP connection handshake, a request, a notification that a client 702 requested content, or any other communication.

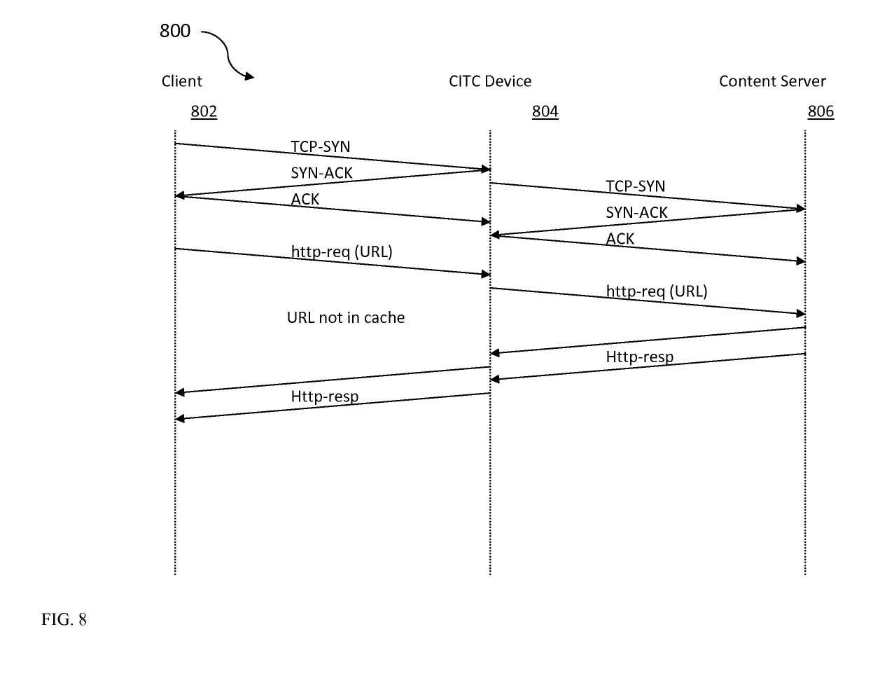

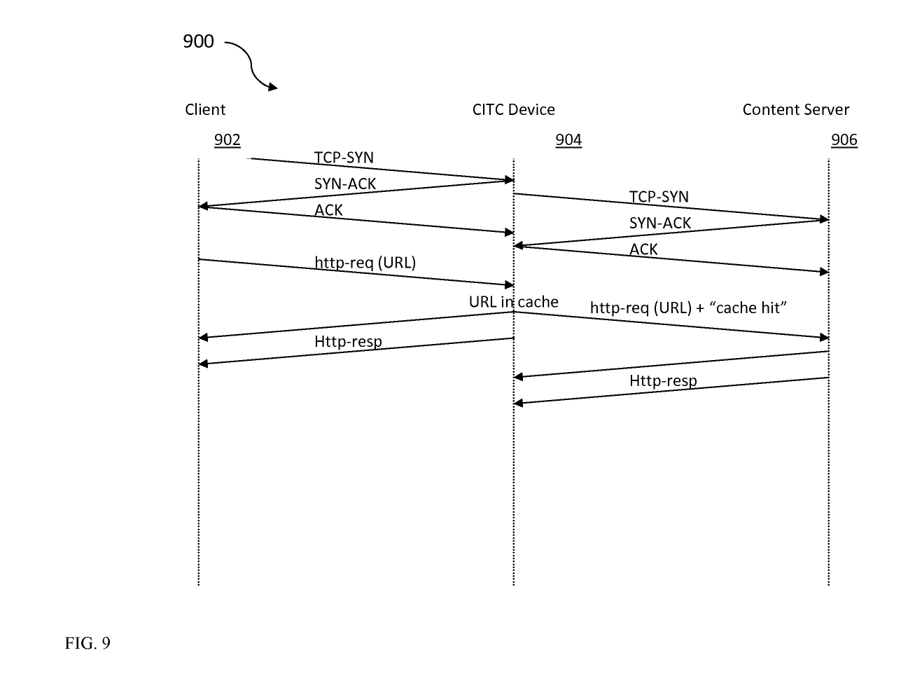

FIG. 8 is a diagram 800 illustrating processing of TCP connections and HTTP requests, in accordance with an embodiment of the invention, when the requested content is not present in the CITC device 804. The client device 802 initiates a standard TCP connection protocol, TCP-SYN, which is received by a CITC device 804. The CITC device 804 responds to the client device 802 with SYN-ACK, and the CITC device 804 then initiates the same TCP connection protocol with the content server 806 by sending TCP-SYN to the content server 806 without waiting for the ACK response from the client device 802. After the content server 806 responds to the CITC device 804 with SYN-ACK, the CITC device 804 responds to the content server 806 with ACK. After the client device 802 responds to the CITC device 804 with ACK, and after the client device 802 sends its HTTP request to the CITC device 804, the proxy/cache sends the HTTP request of the client device 802 to the content server 806. Upon receiving the HTTP response from the content server 806, which may contain the content requested by the client device 802, the CITC device 804 sends that response to the client device 802. As one of skill in the art will understand, the current invention is not limited to only these handshake or transport protocols, and any similar handshake or transport protocol is within the scope of the invention. Regardless of the particular handshake or transport mechanism used, the handshake request from the CITC device 804 to the content server 806 is sent as soon as the handshake request is received from the client 802, or soon thereafter; this is also the case when there is a cache hit. As explained further below in the description of FIG. 9, a handshake request may always be sent by the CITC device 804 to the content server 806 regardless of whether there is a cache hit or miss. In certain embodiments of the invention, the content request from a client device 802 may come from a mobile device or from a RAN cache.

FIG. 9 illustrates the processing of TCP connections and HTTP requests in an embodiment of the invention 900 in the case where the requested content is present in the CITC device 904. The client device 902 initiates a standard TCP connection protocol, TCP-SYN, which is received by the CITC device 904. The CITC device 904 responds to the client device 902 with SYN-ACK, and the CITC device 904 then initiates the same TCP connection protocol with the content server 906 by sending TCP-SYN to the content server 906 without waiting for the ACK response from the client device 902. After the content server 906 responds to the CITC device 904 with SYN-ACK, the CITC device 904 responds to the content server 906 with ACK. After the client device 902 responds to the CITC device 904 with ACK, and after the client device 902 sends its HTTP request to the CITC device 904, the CITC device 904 recognizes that the content requested by the HTTP request is stored in the CITC device 904. The CITC device 904 then sends the HTTP request of the client device 902 to the content server 906. The CITC device 904 may also send information conveying the fact that the HTTP request from the client device 902 was a “cache hit” because the requested content was in the CITC device 904, and the CITC device 904 may also tag the request sent to the content server 906 with a tag indicating the presence of a content-origin-server-friendly RAN cache (termed “CITC-tag”). At the same time that the CITC device 904 sends the request of the client device 902 to the content server 906, or after that, the CITC device 904 sends the requested content to the client device 902 as an HTTP response. After the content server 906 receives the HTTP request and “cache hit” transmission from the CITC device 904, the content server 906 sends an HTTP response to the CITC device 904, which may contain the content requested by the client device 902. The CITC device 904 then updates the expiration time and other tags on the cached content based on the response from the content server 906.

In certain embodiments of the invention, when the CITC device 904 is delivering content to a client device 902, the delivery time over the RAN is longer than the time it takes for the content server 906 to return the response to the CITC device 904. In these embodiments, the CITC device 904 acts on any error indications in the response applicable to that client device 902 by terminating the ongoing delivery of the cached content. The content may be organized into a relatively small prefix-portion and a relatively large suffix-portion, so that when both are in the CITC device 904 (i.e., there is a cache hit), the CITC device 904 may start serving the prefix-portion and forward the request to the content server 906 in parallel to verify that the object is still valid and that the requesting client device 902 is authorized to download the content. In such an embodiment, the response of the content server 906 instructs the CITC device 904 whether or not to serve the remaining suffix-portion of the content to the client device 902. These embodiments of the invention may entail digital rights management (“DRM”), legal intercept (“LI”) methods deployed in the core network, or other types of content protection or control.

In some configurations, an operator of a content-origin server may employ an LI control-policy node to enable LI operation for a specific user's mobile device. A core-network device, such as a SGSN or GGSN, may provide support for these LI functions; for example, the LI control-policy node initiates an LI trigger for the specific user's mobile device, and the core-network device may deliver a copy of the user's data packets to the LI device for verification, authentication, or other purposes. Any objects previously cached by the CITC/RAN cache device and delivered to the user device, however, may not be visible to the core-network devices.

In one embodiment of the current invention, the CITC systems and methods described above are used to provide this visibility. The CITC operation may be engaged when the LI trigger is received for a specific user's mobile device. Because the CITC device propagates user requests upstream to the content-origin server, even if the requested content is locally in the cache, all data delivered to the specific user's device may be visible to the core-network device, thus meeting LI requirements.

In certain embodiments of the invention, the operation of the CITC device 904 fetching the cached content from the content server 906 in parallel with delivering the cached content may enable the content server 906 to deliver dynamic objects in a pipelined fashion. For example, while delivering dynamic content, the content server 906 may deliver different content objects for the same content request, so that the content server 906 may maintain a pipeline of such dynamic content in the CITC device 904, with the current content in line to be sent to a subsequent client request.

The response of the content server 906 may include content modified for compatibility with the content-origin-server-friendly RAN cache 904, for example, video content may be scaled down in quality to conserve bandwidth. The response may further include content flagged as cacheable or having an increased expiration time to better utilize the CITC device 904. For example, if the server 906 recognizes the CITC device 904 as friendly, it may allow more content to be cached therein for longer periods of time. The response may also include content to be served in a future request (e.g., one or more advertisements).

In various embodiments, the CITC device monitors the amount of data flowing in and out of the RAN cache (e.g., the content received from the content-origin server and/or the content served to the mobile device). By comparing these two sets of data (e.g., calculating the down-stream charging difference), the CITC device may indicate an overcharging event (i.e., more data has been received from the content-origin server than has been served to the mobile device) or an undercharging event (i.e., less data has been received from the content-origin server than has been served to the mobile device). The outcome of the comparison may be reported upstream to the core network/charging device or content-origin server or, in other embodiments, may be used to control the amount of data delivered from the RAN cache. For example, if a user is currently being undercharged, the CITC device may limit serving more data from the RAN cache, and if the user is overcharged, the CITC device may increase the amount of data served from the RAN cache. This monitoring and correcting of data served to the mobile device may minimize the impact on any accounting and/or charging system in the mobile core network at least because those systems may assume that a user is neither under- or over-charged (or under- or over-charged only within a small tolerance). The systems may further minimize the impact on any legal intercept issues in the mobile core network.

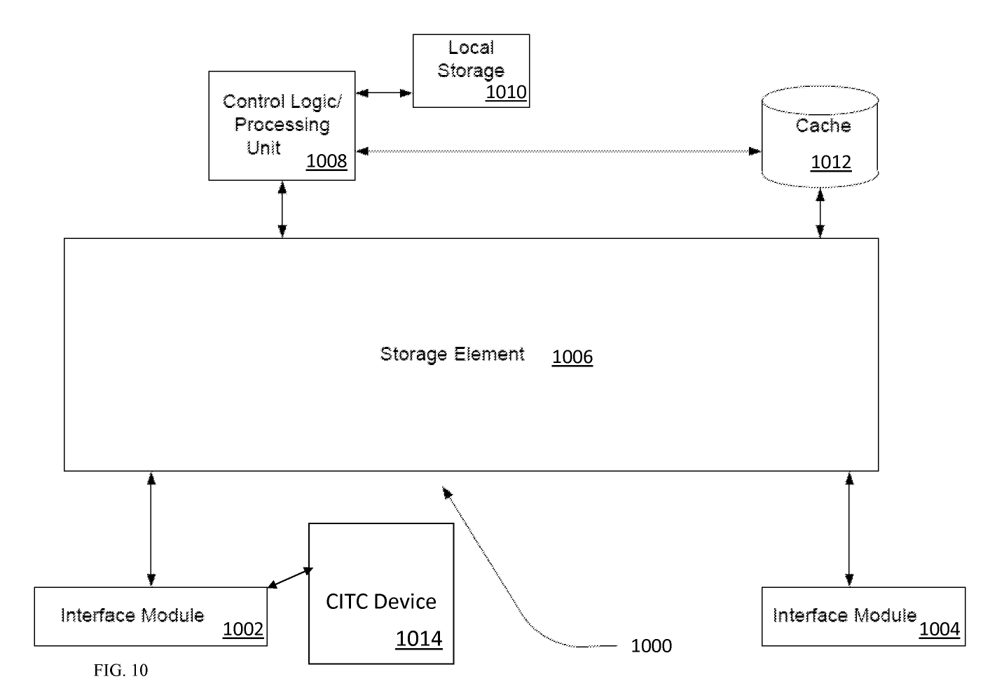

FIG. 10 is a block diagram of one embodiment of a RAN cache 1000. The RAN cache 1000 delivers locally cached content, terminates a client-side application session, and/or uses a different session for communication with the home server. The RAN cache 1000 includes two interface modules 1002, 1004 for the hardware signaling required to communicate with other devices in the RAN using an appropriate interface and software protocol (e.g., IuB, IuPS, or Gn). Each interface module 1002, 1004 may receive and/or transmit data on the selected interface. Received data may be placed into a storage element 1006. The movement of data between the interface modules 1002, 1004 and the storage element 1006 may involve dedicated hardware, such as a DMA controller or a dedicated data-movement processor. The processing of control-plane and user-plane tunnels within the RAN cache 1000 (on, e.g., the interfaces that connect to RAN devices) is in accordance with the RAN specifications. The processing of application protocols within these user-plane tunnels is per the application proxy, caching, or other policies with the RAN cache device 1000. This data processing may be accomplished using dedicated control logic or a processing unit 1008. The control logic/processing unit 1008 may have its own local storage element 1010, which contains instructions to execute and store local status. Using known specifications and protocols, the control logic/processing unit 1008 parses the received information to understand received packets at each protocol layer. A cache storage element 1012 may also be included for holding cached information. The RAN cache 100 is further described in U.S. patent application Ser. No. 12/536,537, the entire specification of which is hereby incorporated herein by reference in its entirety.

The storage element 1006, local storage 1010, and cache 1012 may be implemented with any appropriate storage technology known in the art, such as random-access memory, flash memory, or a block storage device (e.g., a magnetic or solid-state disk). The control logic/processing unit 1008 may be a general-purpose processor and executing a set of instructions from an internal or external storage device. In other embodiments, the control logic/processing unit 1008 is a dedicated hardware device having embedded instructions or a state machine. The CITC device 1014 may interface with the RAN cache 1000, such as through the interface module 1002 in the present embodiment of the invention.

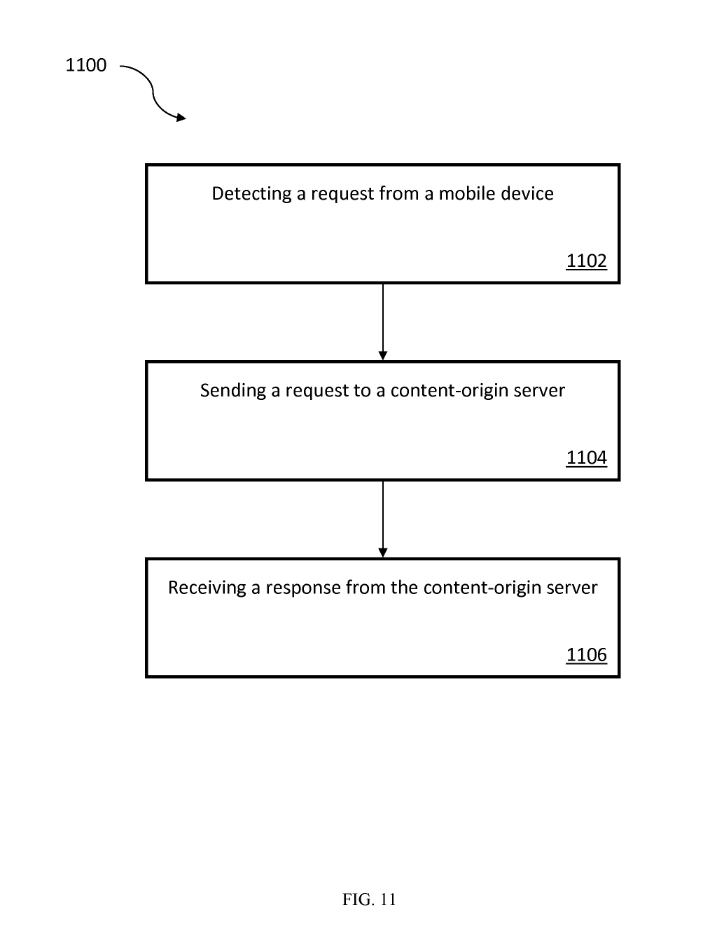

FIG. 11 is a block diagram illustrating a charging-invariant transit caching process 1100 in accordance with an embodiment of the invention. The method may include detecting a request from a mobile device for content present in the RAN cache (step 1102), sending a request to a content-origin server (step 1104), and receiving a response from the content-origin server related to the request (step 1106).

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for serving content from a radio-access network cache, the method comprising:
detecting a request, from a mobile device, for content present in the radio-access network cache;
sending the request to a content-origin server; and
receiving a response from the content-origin server related to the request.

2. The method of claim 1, wherein detecting the request comprises receiving a client request from the mobile device or from the radio-access network cache.

3. The method of claim 1, wherein the response received from the content-origin server comprises the requested content.

4. The method of claim 1, wherein the response received from the content-origin server comprises an indication to halt serving the content from the radio-access network cache.

5. The method of claim 4, wherein the indication comprises a message that the request is denied or that the content requested is invalid.

6. The method of claim 4, further comprising instructing the radio-access network cache to halt serving the content.

7. The method of claim 1, wherein sending the request to the content-origin server occurs in parallel with serving the content from the radio-access network cache.

8. The method of claim 1, wherein sending the request to the content-origin server occurs after serving the content from the radio-access network cache.

9. The method of claim 1, further comprising tagging the request sent to the content-origin server with a tag indicating presence of a content-origin-server-friendly radio-access network cache.

10. The method of claim 9, wherein the response received from the content-origin server comprises content modified for compatibility with the content-origin-server-friendly radio-access network cache.

11. The method of claim 10, wherein the modifications comprise flagging the content as cacheable or increasing the expiration time of the content.

12. The method of claim 9, wherein the response received from the content-origin server comprises content to be served in a future request.

13. The method of claim 12, wherein the content to be served in the future request comprises an advertisement.

14. The method of claim 1, further comprising comparing an amount of data delivered to the mobile device to an amount of data received from the content-origin server.

15. The method of claim 14, further comprising indicating undercharging or overcharging based on an outcome of the comparison.

16. The method of claim 14, further comprising controlling an amount of data delivered from the radio-access network cache, prior to fetching the data from the content-origin server, based on an outcome of the comparison.

17. The method of claim 16, wherein controlling the amount of delivered data minimizes an impact on an accounting and charging system in a mobile core network.

18. The method of claim 16, wherein controlling the amount of delivered data minimizes an impact on any legal intercept issues in a mobile core network.

19. The method of claim 1, further comprising delivering the content to a legal-intercept control-policy node and receiving verification therefrom prior to delivering the content to the mobile device.

20. A system for serving content from a radio-access network cache, the system comprising:
an interface module for sending data to and receiving data from a radio-access network;
a detection module for detecting a request, sent from a mobile device and received via the radio-access network, for content present in a radio-access network cache; and
a communication module for sending the request to a content-origin server and receiving a response therefrom.

21. The system of claim 20, further comprising a security module for verifying that the mobile device is allowed to receive the content.

22. The system of claim 21, wherein the security module halts serving of the content from the radio-access network cache if the mobile device is not allowed to receive the content.

23. The system of claim 20, wherein the communication module receives the content from the content-origin server.

24. The system of claim 20, wherein the communication module tags the forwarded request with a tag indicating presence of a content-origin-server-friendly radio-access network cache.

25. The system of claim 20, further comprising an accounting module for comparing an amount of data delivered to the mobile device to an amount of data received from the content-origin server.

26. The system of claim 20, further comprising a cache-interface module for communicating with a radio-access network cache.

27. The system of claim 26, wherein the cache-interface module forwards content received from the content-origin server to the radio-access network cache.

28. A system for serving content from a radio-access network cache, the system comprising:
computer memory for storing instructions for:
i. detecting a request, sent from a mobile device via a radio-access network, for content present in the radio-access network cache,
ii. sending the request to a content-origin server, and
iii. receiving a response from the content-origin server related the request; and
a processor for executing the instructions.
